(19) United States
(12) Patent Application Publication
(10) Pub. No.: US 2010/0284427 A1
(43) Pub. Date: Nov. 11, 2010

(54) METHOD, COMMUNICATION APPARATUS FOR TRANSMITTING DATA IN A COMMUNICATION SYSTEM AND THE COMMUNICATION SYSTEM

(76) Inventors: Guangyi Liu, Beijing (CN); Lu Han, Beijing (CN); Qixing Wang, Beijing (CN); Yuhong Huang, Beijing (CN)

Correspondence Address: Vierra Magen Marcus & DeNiro LLP, 575 Market Street, Suite 2500, San Francisco, CA, 94105, US

(21) Appl. No.: 12/810,836

(22) PCT Filed: Nov. 21, 2008
(86) PCT No.: PCT/CN2008/001904

§ 371 Date: Jun. 29, 2010

(30) Foreign Application Priority Data
Dec. 29, 2007 (CN) 200710304758.4

(51) Int. Cl. H04J 13/00

(52) U.S. Cl. 370/479

(57) ABSTRACT

A method, a communication device for transmitting data in a communication system, and the communication system. The method includes: detecting the current channel quality; determining the overlapping coding times corresponding to the detected channel quality according to the corresponding relation between the channel quality and the overlapping coding frequency; performing coding operation of overlapping coding multiplexing technique to the data which is to be transmitted using the determined overlapping coding times and transmitting the coded data. The method improves the reliability of data transmission under the circumstance of channel quality being relatively poor, and improves the transmission efficiency, avoids the resource waste under the circumstance of channel quality being better.

### FIELD OF THE INVENTION

The present invention relates to a data transmission technology in the communication field, and particularly to a method, communication device for transmitting data in a communication system and the communication system.

### BACKGROUND OF THE INVENTION

The Overlapped Code Division Multiplexing (OVCDM) is a multiplexing technology using coding with high spectral efficiency, which improves the capacity and spectral efficiency of a communication system greatly by parallel convolutional coding with a code rate higher than 1. A coding/decoding scheme using the OVCDM technology may be referred to as an OVCDM coding/decoding operation.

A particular process in which a data symbol is OVCDM coded to implement broadband wireless transmission is shown in FIG. 1. Assuming that serial data including 15 data symbols is input, and the overlapped coding times K is equal to 3, i.e., three data symbols are selected for serial-parallel conversion each time, and then the process includes the following operations.

Operation one: three data symbols are selected for serial-parallel conversion from the serial data to form parallel data in three channels.

In this embodiment, every three data symbols for serial-parallel conversion may be selected in the serial arrangement order.

Operation two: the parallel data in the three channels are convolutional coded respectively.

In this operation, the convolutional coding includes adding input data of the first channel and data stored in registers of the first channel by weight with weight coefficients of {b₀⁰, b₀¹ . . . D₀^{L-1}}, and adding input data of the k^{th} channel and data stored in registers of the K^{th} channel by weight with weight coefficients of {b_{K-1}⁰, b_{K-1}¹ . . . b_{K-1}^{L-1}}, where the b_{K-1}^{L-1} denotes the L^{th} element of a code tap coefficient vector in the K^{th} parallel coding branch, and L denotes a constraint length for the convolutional coding in each channel.

Operation three: parallel input data symbols of the three channels are stored in registers 1 of the respective channels, data originally stored in the registers 1 is stored in registers 2, and data originally stored in the registers 2 is stored in registers 3, and the like.

Data is stored into registers, where, the number of data stored into registers of one channel must not exceed the total number of registers of the channel. Each register stores one data symbol. If all registers of the first channel are stored with date at time t, then data stored in the (L−1)^{th} register is discarded at time t+1. Initially, data stored in the registers is 0.

Operation four: the convolutional coded symbols of the three channels are summed up to form a data symbol in one channel, which is subject to a conversion with an F function, and then the converted data symbol is outputted.

Here, there exists a one-to-one relationship between the F function and input of the F function.

Particularly, the F function is defined as a conversion or mapping of a data symbol. For example,

$$F ( x ) = exp ( j \frac{π}{4} x ) ,$$

that is, after a data symbol x has been obtained by summing up the data symbols of the three channels (assume K=3), the data symbol x is substituted into the F function for calculation, to obtain an output. F(x)=x denotes that the F function is a linear function, and after the data symbol x has been obtained by summing up the data symbols of the three channels, the data symbol x is directly outputted, that is, the F function does not convert data.

As shown in the above coding process, only one data symbol is outputted after K data symbols have been OVCDM coded (equivalent to coding together with modulating). Therefore, spectrum efficiency of the system is increased by K times. That is, by artificially creating overlapped interference between data symbols, high efficiency data transmission can be achieved while obtaining a coding gain.

Since a larger overlapped coding times K and a longer constraint length L for the overlapped coding results in more complex detection, in order to reduce complexity of the detection, a concatenated mode may be adopted to implement an OVCDM process with more overlapped coding times K. The principle of the concatenated OVCDM is as shown in FIG. 2, where the first level of OVCDM1 coding may adopt nonlinear OVCDM coding, and the second level of OVCDM2 coding may adopt linear OVCDM coding. The output of the first level of OVCDM1 coding acts as input of the second level of OVCDM2 coding.

For the OVCDM technology, link performance is related with the overlapped coding times K and the constraint length L for the overlapped coding. For the same overlapped coding times, a longer constraint length leads to better link performance. For different overlapped coding times and the same constraint length, a larger overlapped coding times leads to higher transmission efficiency, but the performance of the Bit Error Ratio (BER) or the Block Error Ratio (BLER) get worse with the same Signal Noise Ratio (SNR).

Detection of the OVCDM coding is Maximum Likelihood Sequence Detection (MLSD) based on a Viterbi algorithm, where an Euclid distance is used as path metric.

OVCDM decoding includes that each data symbol in serial data is decoded into K parallel data symbols, and the parallel data symbols are subjected to parallel-serial conversion, where the number of data symbols obtained from the decoding is K times of the number of data symbols before being decoded. The decoding method may be a Maximum Likelihood Sequence Detection method or a second-best sequence detection method based on a tree diagram. Particularly, Semi-definite programming algorithm of the tree diagram based second-best sequence detection method may be used for decoding.

In an actual cellular mobile communication system, signal strength of communication between a User Equipment (UE) and a base station varies with locations of the UE. For example, even if a distance between a UE A located in a room, a stair well or an elevator and a base station is equal to that between a UE B in open outside and the base station, signal strength of the UE B is higher than that of the UE A. If the UEs A and B are both located in the open outside, then signal strength of the UE A having a shorter distance with the base station is higher than that of the UE B having a longer distance with the base station.

In an OVCDM transmission system, a fixed overlapped coding times K is generally used. In this case, quality of communication channel between a UE and a base station is uncertain when the UE is located at different locations of the communication system. If the channel quality is relatively poor but the value of K is large, then a data transmission error may occur, which reduces the reliability of data transmission. If the channel quality is better but the value of K is small, the transmission efficiency is lowered, which brings about communication resource waste.

### SUMMARY OF THE INVENTION

Embodiments of the present invention provides a method, communication device for transmitting data in a communication system and the communication system, in order to address a problem existing in the prior art that data transmission reliability or transmission efficiency is lowered and hence communication resource waste is caused for failing to choose a suitable overlapped coding times.

An embodiment of the present invention provides a method for transmitting data in a communication system, which includes:

detecting channel quality;

determining an overlapped coding times corresponding to the detected channel quality according to a corresponding relation between the channel quality and the overlapped coding times; and

coding data to be transmitted with the Overlapped Code Division Multiplexing and the determined overlapped coding times and transmitting the coded data.

An embodiment of the present invention provides a communication device, which includes:

a detection module, configured for detecting channel quality; and

a times determining module, configured for determining an overlapped coding times corresponding to the detected channel quality according to a corresponding relation between the channel quality and the overlapped coding times, with the overlapped coding times, a data to be transmitted is coded with the Overlapped Code Division Multiplexing.

An embodiment of the present invention provides a communication system, which includes:

a first device, configured for coding data to be transmitted with a received overlapped coding times and the Overlapped Code Division Multiplexing, and transmitting the coded data; and

a second device, configured for detecting channel quality, determining a corresponding overlapped coding times according to a corresponding relation between the channel quality and the overlapped coding times, transmitting the determined overlapped coding times to the first device, and decoding received coded data with the overlapped coding times and the Overlapped Code Division Multiplexing.

An embodiment of the present invention provides a communication system, which includes:

a first device, configured for determining an overlapped coding times corresponding to received channel quality from a corresponding relation between the channel quality and the overlapped coding times, coding data to be transmitted with the overlapped coding times and the Overlapped Code Division Multiplexing, and transmitting the coded data; and

a second device, configured for detecting channel quality, transmitting the detected channel quality to the first device, and decoding received coded data with the overlapped coding times determined by the first device and the Overlapped Code Division Multiplexing.

An embodiment of the present invention provides a communication system in which uplink and downlink transmission uses the same carrier frequency, and the communication system includes:

a first device, configured for determining channel quality according to a detected channel parameter and received interference information, determining an overlapped coding times corresponding to the channel quality from a corresponding relation between the channel quality and the overlapped coding times, coding data to be transmitted with the overlapped coding times and the Overlapped Code Division Multiplexing, and transmitting the coded data; and

a second device, configured for detecting the interference information, transmitting the interference information to the first device, and decoding received coded data with the overlapped coding times determined by the first device and the Overlapped Code Division Multiplexing.

According to a method for transmitting data in a communication system proposed in an embodiment of the present invention, an optimum overlapped coding times is chosen according to channel quality of the communication system, and an OVDCM coding/decoding operation is performed according to the overlapped coding times, which improves data transmission reliability under the circumstance of worse channel quality, and improves transmission efficiency and avoids resource waste under the circumstance of better channel quality.

### BRIEF DESCRIPTION OF THE DRAWINGS

FIG. 1 is a coding process with the Overlapped Code Division Multiplexing in the prior art;

FIG. 2 is a principle diagram of the concatenated Overlapped Code Division Multiplexing in the prior art;

FIG. 3 is a schematic flowchart of a method for transmitting data in a communication system according to a first embodiment of the present invention;

FIG. 4 is a schematic diagram of concatenated coding according to the first embodiment of the present invention;

FIG. 5 is a schematic diagram of concatenated decoding according to the first embodiment of the present invention;

FIG. 6 is a schematic flowchart of iterative decoding according to the first embodiment of the present invention;

FIG. 7 is a schematic structural diagram of a communication device according to a second embodiment of the present invention; and

FIG. 8 is a schematic structural diagram of a communication system according to a third embodiment of the present invention.

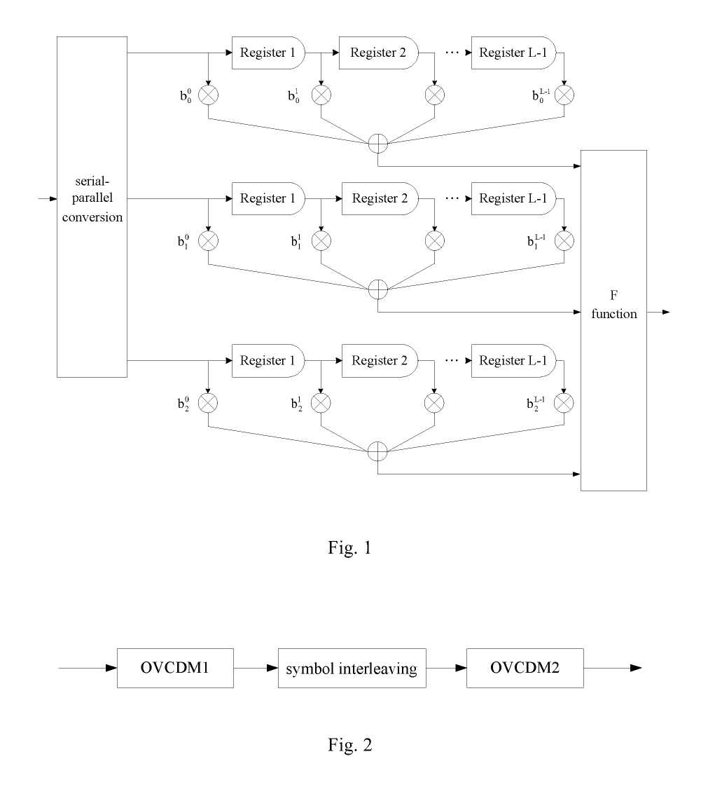

### DETAILED DESCRIPTION OF THE EMBODIMENTS

The present invention is described in detail below with reference to the drawings.

Solutions described in various embodiments of the present invention are based on the OVCDM.

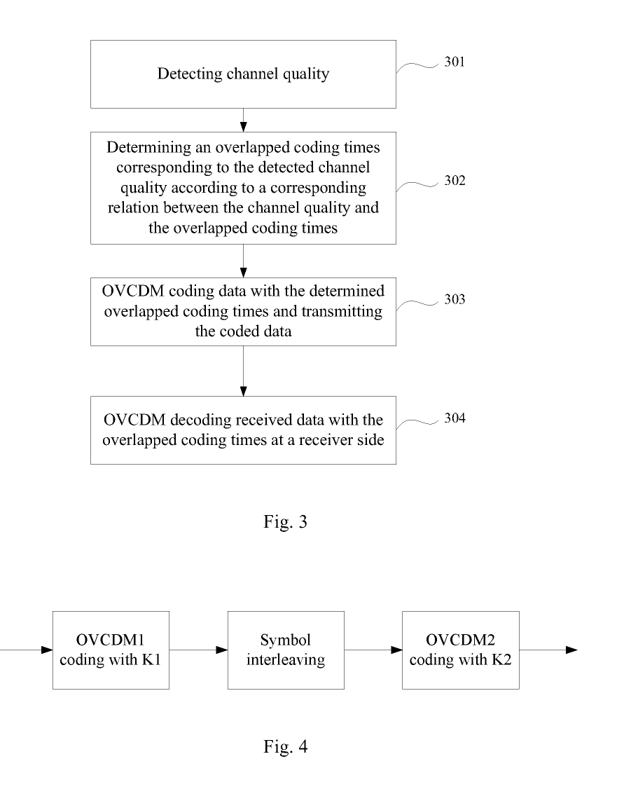

FIG. 3 is a schematic flowchart of a method for transmitting data in a communication system according to a first embodiment of the present invention. As shown in FIG. 3, the method includes the following operations 301 to 304.

Operation 301: channel quality is detected.

In this operation, the detection may be implemented at a receiver side and includes: transmitting at a transmitter side a fixed information to the receiver side before data is transmitted; acquiring at the receiver side various channel parameters when the fixed information is received; and determining at the receiver side the quality of a channel between the transmitter side and the receiver side.

During an uplink data transmission, the transmitter side is a UE and the receiver side is a base station. During a downlink data transmission, the transmitter side is a base station and the receiver side is a UE.

Operation 302: an overlapped coding times corresponding to the detected channel quality is determined according to a corresponding relation between the channel quality and the overlapped coding times.

In this embodiment, if single level OVCDM coding/decoding is performed, then one overlapped coding times corresponds to channel quality within one range. For example, if channel quality is expressed as the value of the Signal Noise Ratio (SNR), then the range of the SNR corresponding to K=1 may be set as (0, 4 dB], a range of the SNR corresponding to K=2 may be set as (4 dB, 9 dB], and the range of the SNR corresponding to K=3 may be set as (9 dB, 13 dB]. When a detected channel SNR is 5 dB, it may be determined, according to the preset corresponding relation between the SNR range and the value of K, that the channel SNR 5 dB belongs to the SNR range (4 dB, 9 dB], and the value of K corresponding to the channel SNR is 2. If concatenated OVCDM coding is performed, then one combination of overlapped coding times of all levels corresponds to channel quality within one range. For example, (K1=1, K2=2) corresponds to a SNR range (0, 4 dB], (K1=2, K2=2) corresponds to a SNR range (4 dB, 9 dB], and (K1=3, K2=1) corresponds to a SNR range (9 dB, 13 dB]. When a detected channel SNR is 5 dB, it may be determined, according to the preset corresponding relation between the SNR range and the value of K, that the channel SNR 5 dB belongs to the SNR range (4 dB, 9 dB], and the value of K corresponding to the channel SNR is: K1=2, K2=2.

The corresponding relation may be stored in the form of a list at the transmitter side and the receiver side, further, information in the list may be modified automatically or manually as required.

Operation 303: data is OVCDM coded with the determined overlapped coding times and the coded data is transmitted.

If single level coding is performed, then OVCDM coding is executed once; if concatenated coding is performed, then OVCDM coding is executed for several times as shown in FIG. 4.

Data is OVCDM coded at the transmitter side with the determined overlapped coding times, and the coded data is transmitted to the receiver side.

Operation 304: received data is OVCDM decoded at the receiver side with the overlapped coding times.

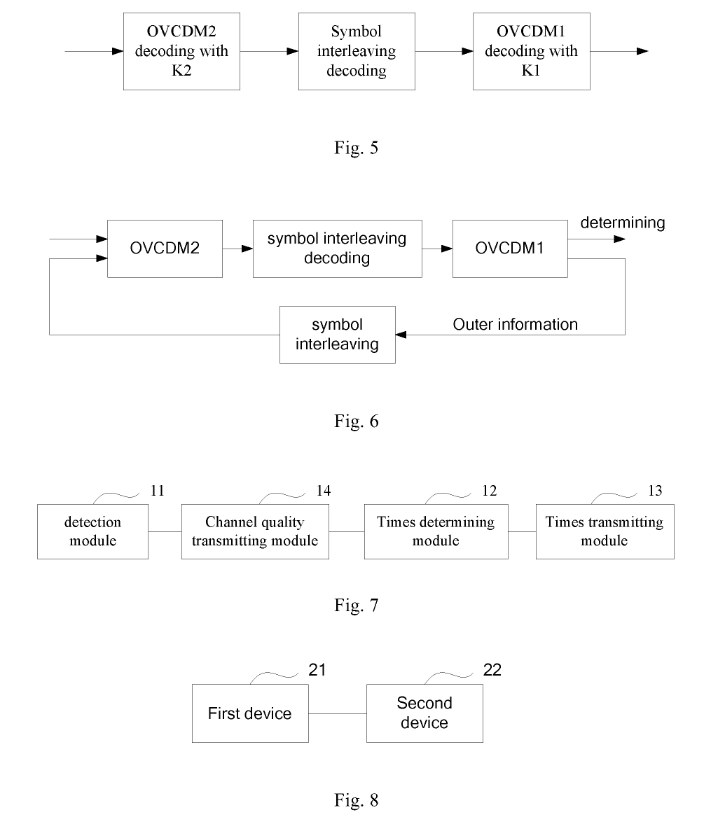

If single level coding is performed, then OVCDM decoding is executed once; if concatenated coding is performed, then OVCDM decoding is executed for several times as shown in FIG. 5. In this embodiment, in order to improve decoding performance, iterative decoding of the concatenated OVCDM may be performed.

Iterative decoding means to perform soft-input soft-output decoding for each level of OVCDM, and decoding performance is improved by an outer information exchange between two levels of OVCDM decoders as shown in FIG. 6. The specific flow is as follows.

Input data symbols are OVCDM2 decoded, the decoded data symbols output from the OVCDM2 are de-interleaved, and the de-interleaved data symbols are OVCDM1 decoded. It is determined whether performance, such as precision, of the decoded data symbols output from the OVCDM1 decoding satisfies a requirement, if the performance satisfies the requirement, then the one iterative operation is completed; otherwise, the next iterative operation is needed, in this case, outer information is fed back to the OVCDM2 decoding from the OVCDM1 decoding, where the outer information output from the OVCDM1 decoding is symbol interleaved as an input to the OVCDM2 decoding; the input data symbol is OVCDM2 decoded again according to the fed outer information, a data symbol output from the OVCDM2 decoding is then de-interleaved as an input to the OVCDM1 decoding for decoding, and then a decision is performed on the decoded data symbol output from the OVCDM1 decoding to complete the second iterative operation. In order to improve decoding performance, many iterative operations may be completed.

The overlapped coding times for the decoding at the receiver side may be obtained in various manners, including, but not limited to, the following two manners.

In a first manner, while data transmitted from the transmitter side is received, the overlapped coding times transmitted from the transmitter side is also received at the receiver side.

In a second manner, after channel quality is detected at the receiver side, the overlapped coding times corresponding to the detected channel quality is determined according to a corresponding relation between the channel quality and the overlapped coding times.

In the operation 302, the detected channel quality may be directly fed to the transmitter side from the receiver side, and the operation 302 is executed at the transmitter side according to the preset corresponding relation between the channel quality and the overlapped coding times. Alternatively, the operation 302 may also be executed at the receiver side and the determined overlapped coding times is fed to the transmitter side from the receiver side.

The channel quality involved in the embodiment is measured by a channel parameter and the interference information. When the channel quality is detected at the receiver side, both the channel parameter and the interference information are detected at the receiver side.

If uplink and downlink transmission of a communication system uses the same carrier frequency, for example the communication system is a Time Division Duplex (TDD) system, then the channel quality may be determined at the transmitter side. For example, during downlink data transmission in the TDD system, the interference information is detected by a UE and returned to a base station; the base station detects the channel parameter information and determines the channel quality according to the received interference information and the detected channel parameter information.

In the operation 303, the OVCDM coding with the determined overlapped coding times includes but not limited to the following two manners.

In a first manner, a code matrix is configured for each overlapped coding times, and the OVCDM coding with the determined overlapped coding times lies in OVCDM coding with b₀⁰ . . . b_{K-1}^{L-1} in a code matrix corresponding to the overlapped coding times.

For example, K=2 may correspond to a code matrix

$$[ \begin{matrix}0.5649 + 0.2366 i & 0.5202 - 0.3271 i \\ 0.0461 + 0.2945 i & - 0.5486 - 0.9260 i\end{matrix} ] ,$$

K=3 may correspond to a code matrix

$$[ \begin{matrix}0.5649 + 0.2366 i & 0.5202 - 0.3271 i \\ 0.0461 + 0.2945 i & - 0.5486 - 0.9260 i \\ 0.7452 + 0.8658 i & 0.4758 + 0.6538 i\end{matrix} ] ,$$

and then a code matrix may be selected according to a determined value of K for performing an OVCDM coding operation.

In a second manner, a code matrix with L columns and K rows is predetermined, where a possible maximum of K may be selected according to an experiential value. Then, after a required overlapped coding times K′ is determined from the operations 301 and 302, K′ rows of data are selected from the code matrix with L columns and K rows for performing the OVCDM coding. For example, K=5 is selected, then a code matrix with L columns and K rows is obtained, and when K′=3 is determined, 3 rows of data are selected from the code matrix with L columns and 5 rows for performing the OVCDM coding.

According to the method of the embodiment of the present invention, a communication device is described in a second embodiment of the invention as shown in FIG. 7. The device includes a detection module 11 and a times determining module 12. The detection module 11 is configured for detecting channel quality, and the times determining module 12 is configured for determining an overlapped coding times corresponding to the detected channel quality according to a corresponding relation between the channel quality and the overlapped coding times. With the overlapped coding times, data to be transmitted is coded with the Overlapped Code Division Multiplexing.

The device further includes a times transmitting module 13, configured for coding and transmitting the overlapped coding times determined by the times determining module 12 to the data transmission peer in the communication system.

The device further includes a channel quality transmitting module 14 configured for transmitting the channel quality detected by the detection module 11 located at the receiver side of the communication system to the times determining module 12.

On the basis of the first and second embodiments, a third embodiment of the present invention further provides a communication system as shown in FIG. 8. The system includes a first device 21 and a second device 22. The first device 21 is configured for coding data to be transmitted with the Overlapped Code Division Multiplexing and received overlapped coding times and transmitting the coded data. The second device 22 is configured for detecting channel quality, determining a corresponding overlapped coding times according to a corresponding relation between the channel quality and the overlapped coding times, transmit the determined overlapped coding times to the first device, and decoding received coded data with the overlapped coding times and the Overlapped Code Division Multiplexing.

There is also an alternative solution in the embodiment.

The first device 21 is configured for determining an overlapped coding times corresponding to received channel quality from a corresponding relation between the channel quality and the overlapped coding times, coding data to be transmitted with the overlapped coding times and the Overlapped Code Division Multiplexing, and transmitting the coded data. The second device 22 is configured for detecting channel quality, transmitting the channel quality to the first device, and decoding received coded data with the overlapped coding times determined by the first device and the Overlapped Code Division Multiplexing.

Uplink and downlink transmission of the communication system described in the embodiment uses the same carrier frequency, and the first device 21 and the second device 22 are configured for performing the following operations respectively, the first device 21 is configured for determining channel quality according to the detected channel parameter and the received interference information, determining an overlapped coding times corresponding to the channel quality from a corresponding relation between the channel quality and the overlapped coding times, coding data to be transmitted with the overlapped coding times and the Overlapped Code Division Multiplexing, and transmitting the coded data. The second device 22 is configured for detecting the interference information, transmitting the interference information to the first device, and decoding the received coded data with the overlapped coding times determined by the first device and the Overlapped Code Division Multiplexing.

According to the method, device and the communication system disclosed in the embodiments of the present invention, data transmission reliability is improved under the circumstance of poor channel quality, and transmission efficiency is improved, and thus resource waste is avoided under the circumstance of better channel quality. Further, one of the transmitter side and the receiver side at which the operation of determining an overlapped coding times is performed is selected according to their capacity, which can save the resource of the side with poor capacity.

Apparently, various modifications and alterations can be carried out to the invention by those skilled in the art without deviating the spirit and scope of the invention. Thus, if these modifications and alterations belong to the scope of claims and the equivalent technique of the present invention, then the invention intends to include these modifications and alterations.

1. A method for transmitting data in a communication system, comprising:
detecting channel quality;
determining an overlapped coding times corresponding to the detected channel quality according to a corresponding relation between the channel quality and the overlapped coding times; and
coding data to be transmitted with the Overlapped Code Division Multiplexing and the determined overlapped coding times and transmitting the coded data.

2. The method of claim 1, further comprising:
receiving the coded data, and decoding the data with the overlapped coding times and the Overlapped Code Division Multiplexing at a receiver side.

3. The method of claim 1, wherein, the channel quality is measured by a channel parameter and interference information.

4. The method of claim 1, wherein, the channel quality is detected at a receiver side of the communication system.

5. The method of claim 3, wherein, when uplink and downlink transmission of the communication system uses the same carrier frequency, the interference information is detected at a receiver side of the communication system and returned to a transmitter side; the channel quality is determined at the transmitter side according to the detected channel parameter and the received interference information.

6. The method of claim 4, wherein, after the channel quality has been detected at the receiver side and before the data to be transmitted is coded, the method comprises:
determining the corresponding overlapped coding times according to the detected channel quality at the receiver side, and returning the overlapped coding times to a transmitter side; or
returning the detected channel quality to the transmitter side from the receiver side, and determining the overlapped coding times corresponding to the channel quality at the transmitter side.

7. A communication device, comprising:
a detection module, configured for detecting channel quality;
a times determining module, configured for determining an overlapped coding times corresponding to the detected channel quality according to a corresponding relation between the channel quality and the overlapped coding times, wherein with the overlapped coding times, data to be transmitted is coded with the Overlapped Code Division Multiplexing.

8. The device of claim 7, further comprising:
a times transmitting module, configured for coding and transmitting the overlapped coding times determined by the times determining module to a communication peer.

9. The device of claim 8, further comprising:
a channel quality transmitting module, configured for transmitting the detected channel quality to the times determining module when the detection module is located at an opposite side of the communication system relative to the times determining module.

10. A communication system, comprising:
a first device, configured for coding data to be transmitted with a received overlapped coding times and the Overlapped Code Division Multiplexing, and transmitting the coded data; and
a second device, configured for detecting channel quality, determining a corresponding overlapped coding times according to a corresponding relation between the channel quality and the overlapped coding times, transmitting the determined overlapped coding times to the first device, and decoding the received coded data with the overlapped coding times and the Overlapped Code Division Multiplexing;
or comprising:
a first device, configured for determining an overlapped coding times corresponding to a received channel quality from a corresponding relation between the channel quality and the overlapped coding times, coding data to be transmitted with the overlapped coding times and the Overlapped Code Division Multiplexing, and transmitting the coded data; and
a second device, configured for detecting channel quality, transmitting the detected channel quality to the first device, and decoding the received coded data with the overlapped coding times determined by the first device and the Overlapped Code Division Multiplexing;
or when the same carrier frequency is used for uplink and downlink transmission, comprising:
a first device, configured for determining channel quality according to a detected channel parameter and received interference information, determining an overlapped coding times corresponding to the channel quality from a corresponding relation between the channel quality and the overlapped coding times, coding data to be transmitted with the overlapped coding times and the Overlapped Code Division Multiplexing, and transmitting the coded data; and
a second device, configured for detecting the interference information, transmitting the interference information to the first device, decoding the received coded data with the overlapped coding times determined by the first device and the Overlapped Code Division Multiplexing.

11. (canceled)

12. (canceled)
